(19) United States
(12) Patent Application Publication
(10) Pub. No.: US 2019/0369307 A1
(43) Pub. Date: Dec. 5, 2019

(54) Electromagnetic Radiation Detector Assembly

(71) Applicants: Johan Calcoen, Leuven (BE); Gerald R. Richert, Walla Walla, WA (US); Bert Dirix, Linter (BE)

(72) Inventors: Johan Calcoen, Leuven (BE); Gerald R. Richert, Walla Walla, WA (US); Bert Dirix, Linter (BE)

(73) Assignee: KEY TECHNOLOGY, INC., Walla Walla, WA (US)

(21) Appl. No.: 15/992,825

(22) Filed: May 30, 2018

(51) Int. Cl. G02B 5/02; G01N 21/64; G01N 21/47; G01N 21/21; G02B 26/10; G02B 27/28

(52) U.S. Cl. CPC G02B 5/0284; G01N 21/6456; G01N 21/474; G01N 2201/0648; G02B 26/105; G02B 27/288; G01N 2201/0636; G01N 21/21

(57) ABSTRACT

An electromagnetic radiation detector assembly is described and which includes an optical scattering mirror which optically interacts with a source of bulk and/or surface scattered electromagnetic radiation coming from the direction of an object of interest so as to function, at least in part, as a bulk scattered and/or surface scattered spatial input filter; and electromagnetic radiation detectors are provided and which are oriented in fixed locations relative to the optical scattering mirror so as to detect, with an improved signal-to-noise ratio, the bulk and/or surface scattered electromagnetic radiation; or another source of electromagnetic radiation coming from the direction of the object of interest, and then generate a resulting image signal having improved contrast.

### TECHNICAL FIELD

The present invention relates to an electromagnetic radiation detector assembly which is useful in detecting objects of interest when it is used in a sorting device, and more specifically, to an electromagnetic radiation detector assembly which selectively detects, with an improved signal-to-noise ratio, bulk, and/or surface scattered electromagnetic radiation, and then generates a resulting image signal having greatly improved contrast.

### BACKGROUND OF THE INVENTION

The use of laser scanners, and the detectors for same in sorting machines or devices of various designs has long been known. Prior art laser scanner detectors have traditionally been configured to detect electromagnetic radiation having different degrees of either bulk scattered, or surface scattered radiation. These detectors have operated by utilizing one or more different shapes, and sizes of spatial input filters or apertures, and which are placed in front of an optical electromagnetic radiation input of these same detectors. In the case of detecting surface scatter electromagnetic radiation, the selected spatial input filter can take on the form of a central obscuration surrounded by an open, or transmissive ring that is a toroidal or donut shaped, and which is located in front of the optical input of the detector. Such spatial input filters typically favor bulk scattered electromagnetic radiation over surface scattered electromagnetic radiation. It should be understood that selecting different sized central obscurations, and ring diameters, can adjust the degree and the amount of the bulk scattered electromagnetic radiation which is collected by a laser scanner detector equipped with this type of detector arrangement.

One of the known advantages of a laser scanner employed in sorting devices as compared to other image capturing devices employed with such devices, is that multiple electromagnetic radiation detectors may be configured, and arranged, to detect multiple electromagnetic radiation effects, or other characteristics generated by a common laser source. More specifically, from just one laser electromagnetic radiation output there can be multiple detectors provided, and which further are optimized to detect different, and selected degrees of bulk scattering, surface scattering, polarization or even florescence. Obviously, more sophisticated sorting machine arrangements which might include, for example, multiple lasers having different electromagnetic radiation wavelengths, may also be present in the resulting laser scanner design. In these increasingly sophisticated designs, each laser which is provided may be associated with multiple different electromagnetic radiation detectors.

As should be appreciated, and as is well known in the art, laser scanner detectors associated with a common laser, and therefore a common electromagnetic radiation wavelength, presently cannot now be opto-mechanically arranged so as to share a common, optical return electromagnetic radiation signal path, and which might include bulk scattered and/or surface scattered electromagnetic radiation signals, as well as polarization information, by way of dichroic beam splitters. It should be appreciated that these common-laser detectors are traditionally arranged around or operationally cooperate with fractional amplitude optical beam-splitters that deviate the path of a common, optical return, electromagnetic radiation signal by a given amplitude. For example, there are commercially available 50/50 beam-splitters; 60/40 beam-splitters and 70/30 beam-splitters, etc.

While the use of fractional, amplitude beam-splitters is well known, such methods and arrangements for operably coupling and orienting laser scanner electromagnetic radiation detectors used in the past have limited the amount of the signal amplitude of every associated detector to something less than 100%. Thus, every associated laser scanner detector has reduced signal-to-noise ratios, which in turn, limits the amount of image contrast that can be generated in any resulting image signal provided by the electromagnetic radiation detectors which are utilized. Furthermore, and in order to achieve even an enhanced contrast, precise, highly accurate, opto-mechanical alignment devices are normally employed with a laser, and with the associated electromagnetic radiation detectors; beam-splitters and spatial input filters. Those skilled in the art will recognize that even with a small amount of misalignment or lack of orientation, of a detector, a beam-splitter or a spatial input filter, can result in significant and adverse effects on the electromagnetic radiation detector's response to the return electromagnetic radiation coming from an object of interest, for example, that is being sorted. Such opto-mechanical alignment is typically tedious, and time consuming, and further can require multiple, expensive, kinematic-type opto-mechanical mounts to co-align the related components in any sorting device which employs same.

The present invention avoids the prior art shortcomings, noted above, by providing an electromagnetic radiation detector which repeatedly demonstrates improved signal-to-noise ratios, enhanced alignment precision, and a novel means by which bulk scattered and surface scattered electromagnetic radiation coming from the direction of an inspection zone may be received, and then processed in a manner not possible, heretofore.

### SUMMARY OF THE INVENTION

A first broad aspect of the present invention relates to an electromagnetic radiation detector assembly which includes a source of electromagnetic radiation which is directed at an object of interest, and which is further scattered, at least in part, from the object of interest in bulk, and/or from a surface thereof, and which further moves in a direction towards the electromagnetic radiation detector assembly; an optical scatter mirror made integral with the electromagnetic radiation detector assembly, and which simultaneously optically interacts with the source of the bulk and/or surface scattered electromagnetic radiation coming from the object of interest so as to function, at least in part, as either a bulk scattered, and/or a surface scattered spatial input filter; and individual electromagnetic radiation detectors which are made integral with the electromagnetic radiation detector assembly, and which are further spatially oriented in fixed, predetermined locations relative to the optical scatter mirror, so as to selectively detect, with an improved signal-to-noise ratio, the bulk scattered electromagnetic radiation; the surface scattered electromagnetic radiation; and/or another source of electromagnetic radiation coming from the direction of the object of interest, and then generate a resulting image signal having improved contrast.

Still another aspect of the present invention relates to an electromagnetic radiation detector assembly which includes a housing having a main body with an outside facing surface, and an opposite, inside facing surface which defines an internal cavity having multiple discreet regions; an optical scatter mirror located within a first discreet region of the internal cavity, and wherein the optical scatter mirror has an aperture which is formed therein, and which passes therethrough; an optical beam splitter located within a second discreet region of the internal cavity, and which is further positioned in an optical receiving relationship relative to the aperture formed in the optical scatter mirror; a first electromagnetic radiation detector mounted in a first, predetermined location on the outside facing surface of the housing, and in a first, optical receiving orientation relative to the optical beam splitter; a second electromagnetic radiation detector mounted in a second, predetermined location on the outside facing surface of the housing, and in a second, optical receiving orientation receiving orientation relative to the optical beam splitter; a third electromagnetic radiation detector mounted in a third, predetermined location on the outside facing surface of the housing, and in an optical receiving orientation relative to the optical scatter mirror; and an optical bandpass filter which is mounted on the housing and disposed in an optical transmitting relationship relative to the optical scatter mirror, and which further passes a source of electromagnetic radiation which is optically scattered, at least in part, from an object of interest in bulk, and/or from a surface thereof, into the first discreet region of the internal cavity and to the optical scatter mirror which is located within the first discreet region of the internal cavity, and wherein the optical scatter mirror reflects and/or passes, at least in part, a portion of the scattered electromagnetic radiation which is passed by the optical band pass filter.

Still further and more specifically the present invention relates to an electromagnetic radiation detector assembly which includes a selectively adjustable base plate for supporting the electromagnetic radiation detector in a predetermined horizontal and vertical orientation, and wherein the base plate has an upwardly, and outwardly facing supporting surface, and which is further defined, in part, by a peripheral edge; a housing having a main body which defines an internal cavity having predetermined first, second, third and fourth regions, and which further has spaced apart, upper and lower outwardly facing surfaces, and first, second, third and fourth, outwardly facing sidewall surfaces which individually extend between the upper and lower outwardly facing surfaces of the housing, and wherein the lower and outwardly facing surface of the housing is mounted on the upwardly, and outwardly facing supporting surface of the selectively adjustable base plate; an optical scatter mirror mounted in a predetermined spatial and optical reflecting and transmitting orientation within the first region of the internal cavity as defined by the housing, and wherein the optical scatter mirror has an aperture formed therein, and which further extends therethrough; an optical beam splitter positioned within the second region of the internal cavity as defined by the housing, and wherein the optical beam splitter is located in a predetermined, spaced relationship, and in an optical receiving relationship relative to the optical scatter mirror; a first lens received, and supported, at least in part, within the third region of the internal cavity as defined by the housing, and wherein the first lens is positioned in a predetermined, spaced relationship, and in an optical receiving relationship relative to the optical beam splitter, and wherein the optical scatter mirror, optical beam splitter and first lens are linearly aligned along a first, predetermined line of reference, one relative to the others; a first electromagnetic radiation detector which is mounted on the third, outwardly facing sidewall surface of the housing, and which is further oriented in an optical receiving relationship relative to the first lens; a second lens received and supported, at least in part, within the fourth region of the internal cavity as defined by the housing, and wherein the second lens is positioned in optical receiving relation relative to the optical beam splitter, and is further spatially oriented, laterally outwardly relative to the first, predetermined line of reference as defined, at least in part, by the optical scatter mirror, optical beam splitter, and the first lens; a second electromagnetic radiation detector mounted on the second, outwardly facing sidewall surface of the housing, and which is further oriented in an optical receiving relationship relative to the second lens; a sensor mounting plate having a predetermined, spaced, outwardly facing, top and bottom surfaces, and which further defines an optical passageway which communicates with both of the outwardly facing, top, and bottom surfaces thereof, and wherein the outwardly facing, bottom surface of the sensor mounting plate is mounted on the upper, outwardly facing surface of the housing, and wherein the optical passageway of the sensor mounting plate is oriented in an optical receiving relationship relative to the optical scatter mirror, and which is further located within the first region as defined by the internal cavity of the housing; a third lens which is received and supported, at least in part, within the optical passageway as defined by the sensor mounting plate, and wherein the third lens is oriented in an optical receiving relationship relative to the first region of the internal cavity as defined by the housing; a third electromagnetic radiation detector which is mounted on the top, outwardly facing surface of the sensor mounting plate, and which is further oriented in an optical receiving relationship relative to the third lens; an optical bandpass filter which is mounted in a spaced relationship relative to the first, outwardly facing sidewall of the housing, and which is further positioned in an optical transmitting relationship relative to the first region of the internal cavity, as defined by the housing, and the optical scatter mirror which is positioned within the first region, and wherein the optical band pass filter is further oriented along the first, predetermined line of reference; a first, optical polarizing lens which is mounted on the first, outwardly facing sidewall of the housing, and which is further oriented in a spaced, optical receiving relationship relative to the optical band pass filter, and wherein the first, optical polarizing lens is further positioned in an optical transmitting relationship relative to the first region of the internal cavity, as defined by the housing, and the optical scatter mirror which is positioned within the first region, and wherein the first, optical band pass filter is further oriented along the first, predetermined line of reference; and a second, optical polarizing lens which is mounted on the outside facing, bottom surface of the sensor mounting plate, and which is further oriented in an optical receiving relationship relative to the first region of the internal cavity of the housing, and the optical scatter mirror which is positioned within the first region of the housing, and wherein the second, optical polarizing lens is further positioned in an optical transmitting relationship relative to the third lens which is supported, at least in part, within the optical passageway as defined by the sensor mounting plate, and wherein the optical scatter mirror; second, optical polarizing lens; third lens; and the third electromagnetic radiation detector are each oriented along a second, predetermined line of reference which is oriented in a perpendicular relationship relative to the first, predetermined line of reference.

These and other aspects of the present invention will be discussed in greater detail hereinafter.

### BRIEF DESCRIPTION OF THE DRAWINGS

FIG. 1 is a perspective, side elevation view of the electromagnetic radiation detector assembly of the present invention.

FIG. 2 is a rear, side elevation view of the present invention.

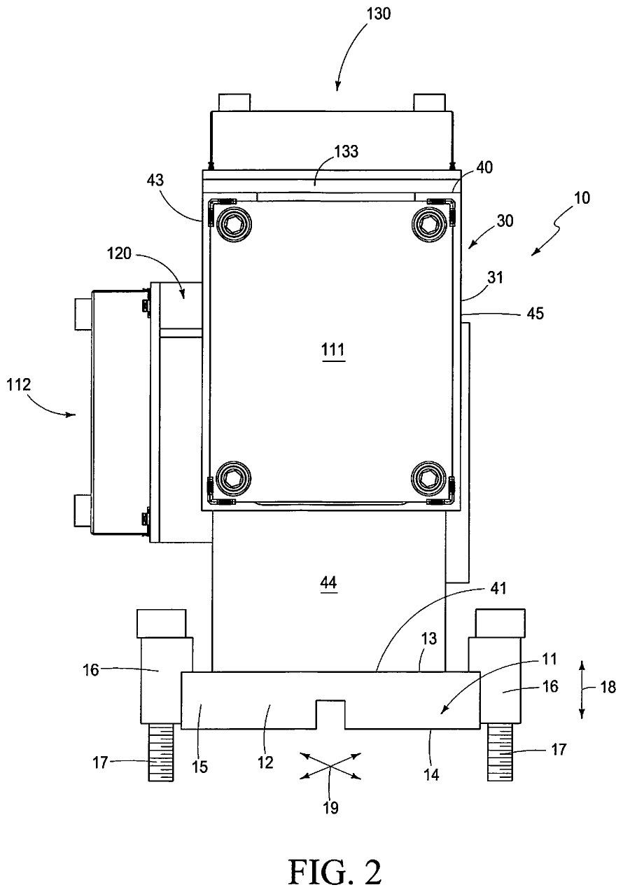

FIG. 3 is a first, side elevation view of the present invention.

FIG. 4 is a front, side elevation view of the present invention.

FIG. 5 is a transverse, horizontal sectional view taken from a position along line 5-5 of FIG. 1.

FIG. 6 is a transverse, vertical sectional view taken from a position along line 6-6 of FIG. 1.

FIG. 7 is an exploded, perspective, side elevation view of a portion of the invention as seen in FIG. 1.

FIG. 8 is a schematic, greatly simplified depiction of a sorting apparatus which might employ the electromagnetic radiation detector assembly of the present invention so as to produce image signals having improved contrast.

FIG. 9 is a greatly simplified depiction of a sorting apparatus of a second design which would utilize the electromagnetic radiation detector of the present invention.

FIG. 10 is a greatly enlarged, transverse sectional view of the optical scattering mirror which forms a feature of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

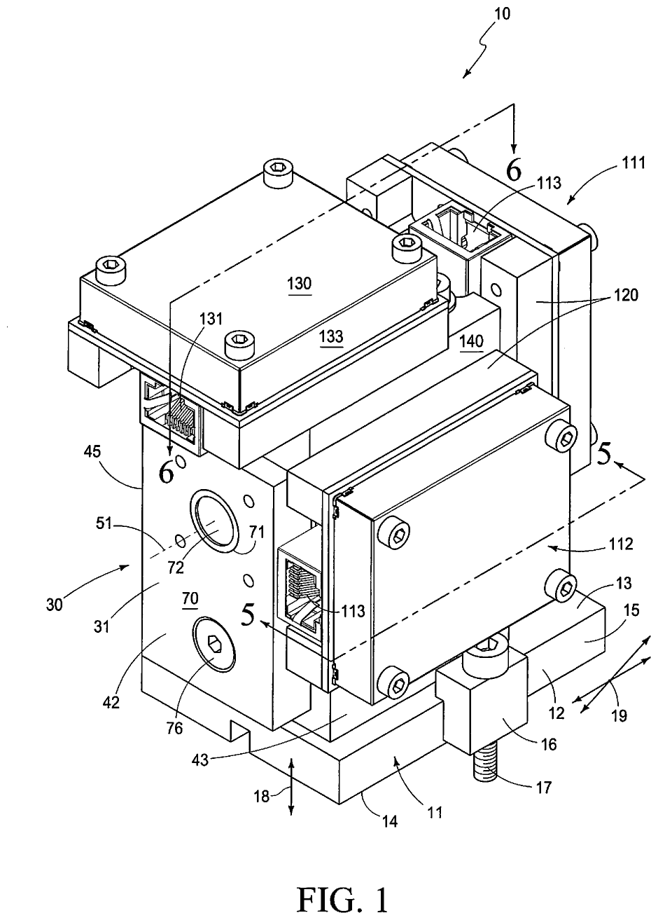

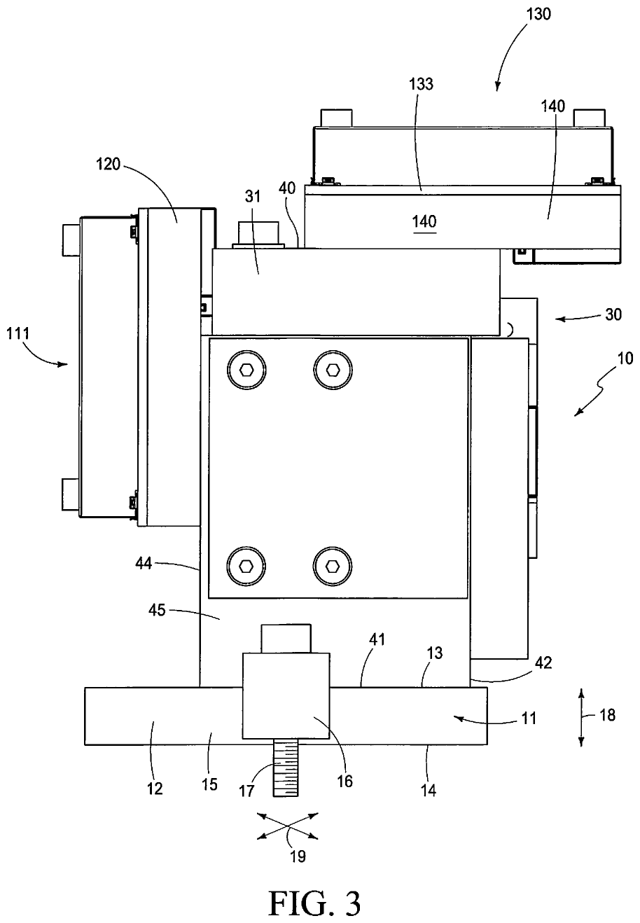

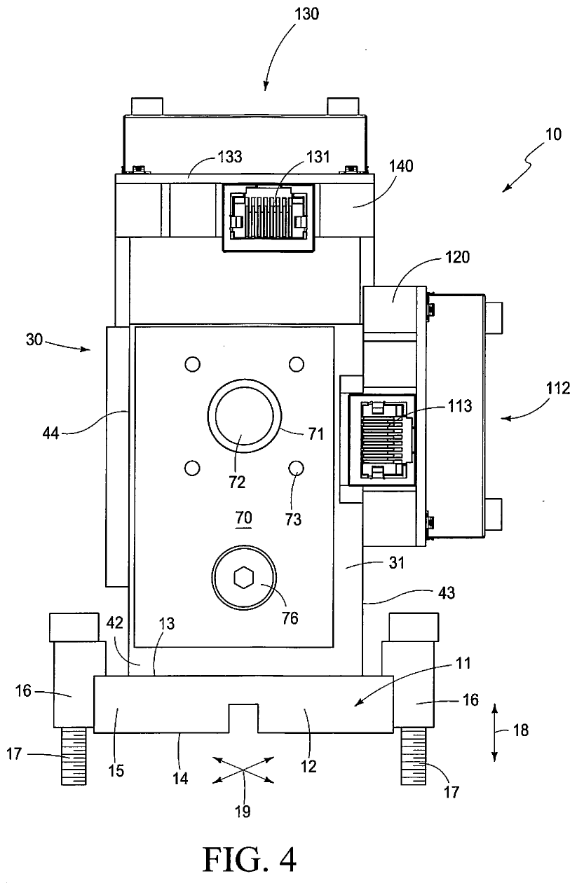

The electromagnetic radiation detector assembly of the present invention is generally indicated by the numeral 10 in FIG. 1, and following. The present invention includes, as a first aspect, a selectively adjustable base plate which is generally indicated by the numeral 11 in FIG. 1. The selectively adjustable base plate 11 has a generally planar shaped main body 12, and which has an upwardly and outwardly facing supporting surface 13, and a downwardly and outwardly facing surface 14. Further, the main body 12 is defined, in part, by a peripheral edge 15. As seen in the drawings, the base plate 11 includes a multiplicity of bolt receiving members 16 which are positioned in given, predetermined locations along the peripheral edge 15. As seen in FIGS. 3 and 4, it will be noted that at least two bolt receiving members 16 are positioned along one portion of the peripheral edge 15; and at least one bolt receiving member 16 is positioned on another portion of the peripheral edge 15, and which is located opposite to the peripheral edge portion having the two bolt receiving members 16. Each of the bolt receiving members 16 are operable to threadably mate or otherwise cooperate with individual threaded bolts 17, and which may be individually, threadably advanced to various debts within the bolt receiving members 16 so as to allow a distal end of the individual threaded bolts 17 to engage an underlying supporting surface. This threadable advancement allows for a precise, spatial adjustment of the adjustable baseplate in either a vertical plane 18 and/or given horizontal plane 19.

The electromagnetic radiation detector assembly 10 includes a housing 30 which is operable to be attached to the upwardly, and outwardly facing surface 13 of the selectively adjustable base plate 11. The housing 30 is defined, at least in part, by an outwardly facing surface 31, and an opposite, inwardly facing surface 32. The inside facing surface 32 defines an internal cavity 33. The aforementioned internal cavity 33 has discreet first, second, third and fourth regions, and which are generally indicated by the numerals 34, 35, 36 and 37, respectively. The respective regions of the internal cavity 33 are operable to optimally position various subcomponents of the present invention, and which will be discussed in greater detail, hereinafter.

The housing 30, as discussed, above, is defined, at least in part, by an upper, top or outwardly facing surface 40, and a lower, bottom or outwardly facing surface 41, and which is disposed in a predetermined, substantially parallel, spaced relationship, one relative to the other. Still further the housing 30 is defined, at least in part, by first, second, third and fourth outwardly facing sidewall surfaces, and which are generally indicated by the numerals 42, 43, 44 and 45, respectively. These respective first, second, third and fourth outwardly facing surfaces generally define a rectangular housing structure providing at least some outer peripheral boundaries for the first, second, third and fourth regions of the internal cavity 33. While the housing 30, as seen in the drawings is depicted as a generally rectangular shaped structure, it is conceivable that other shapes could work with equal success assuming the spatial orientations of the components of the invention, as will be discussed, hereinafter, could be achieved by the new housing shape which was selected.

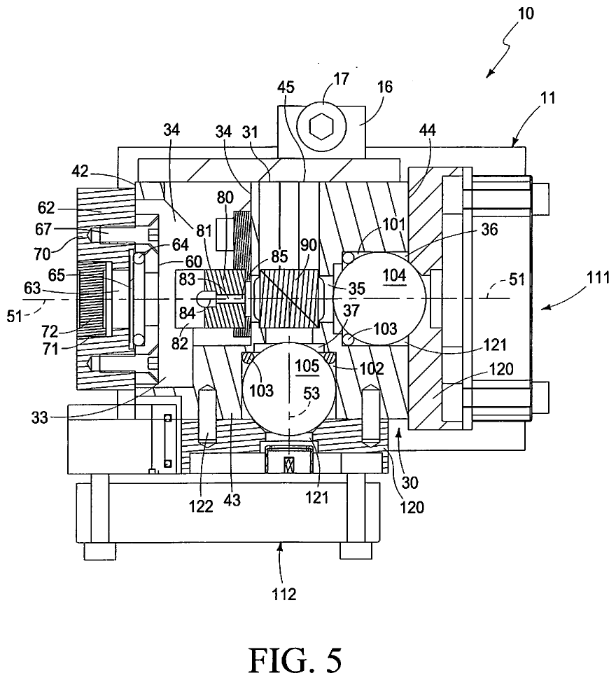

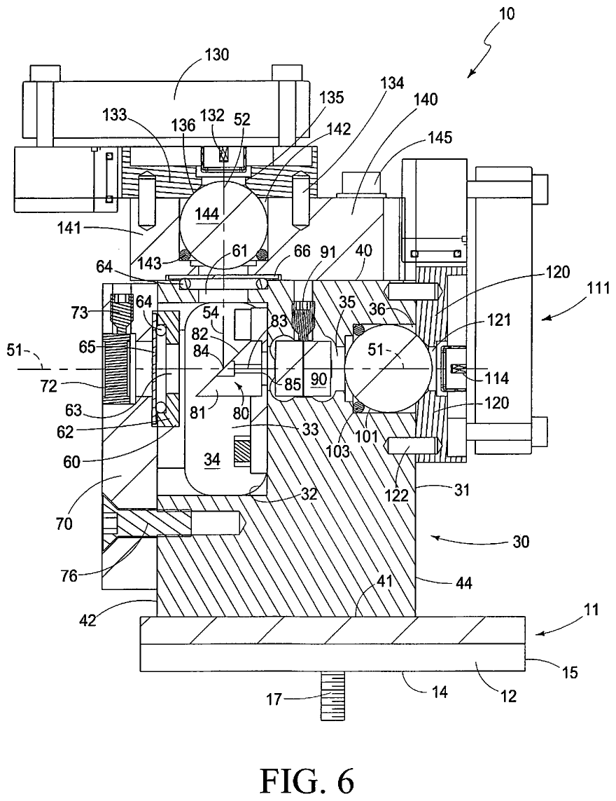

As seen in the drawings, and more specifically by reference to FIGS. 5 and 6, the electromagnetic radiation detector assembly 10, and more specifically, the housing 30, thereof, is defined, at least in part, by predetermined first, second, and third lines of references 51, 52 and 53, respectively. These specific lines of references are being employed in the attached drawings to aide and assist in the understanding of the orientation of the various subassemblies and components which form features of the present invention. It should be understood that the respective first, second and third lines of reference 51, 52, and 53 are oriented in a substantially perpendicular relationship one relative to the others.

As best seen by reference to FIG. 5, the housing 30, and more specifically the first, outwardly facing surface 42, has a plate polarizer cavity 60 formed therein. The plate polarizer cavity 60 is coupled in optical transmitting relation relative to the first region 34, and which forms a portion of the internal cavity 33. As seen in FIG. 6, an optical passageway 61 is formed in the upper, or top facing surface 40 of the housing 30, and extends therethrough. As also seen in FIG. 6, a clamp plate 62 is received in the plate polarizer cavity 60 as previously described. An aperture 63 is formed in the clamp plate 62, and further, an O-ring seal 64 is received within each of the aperture 63, and the optical passageway 61. As further seen in FIG. 6 a first, plate polarizer 65 is received within and occludes the aperture 63, and is further oriented in rested, sealing engagement thereagainst the O-ring seal 64. Further a second plate polarizer 66 is received within and occludes the optical passageway 61. The second plate polarizer 66 is also disposed in rested, sealing relation relative to the O-ring seal 64, and which is positioned in the optical passageway 61. A fastener 67 (FIG. 5) secures the first plate polarizer 65 in an occluding orientation within the aperture 63, and which is formed in the clamp plate 62. The clamp plate 62 is threadably secured to the first outwardly facing surface 42 by suitable fasteners.

A filter detector mounting plate 70 (FIG. 6) is provided, and is further threadably affixed to the first, outwardly facing sidewall surface 42, of the housing 30. The filter detector mounting plate 70 defines a predetermined aperture 71 (FIG. 5), and further, a band pass filter 72 is received within and disposed in a substantially occluding relationship relative to the aperture 71. As illustrated, a threaded fastener 73 is provided, and which releasably secures the band pass filter 72 in a secure and optimal spatial relationship relative to the aperture 71. As will be appreciated, the band pass filter 72, and first plate polarizer 65 are each oriented along the predetermined line of reference 51 which as was discussed, above. A threaded fastener 74 secures the filter detector mounting plate to the housing 30 (FIG. 6).

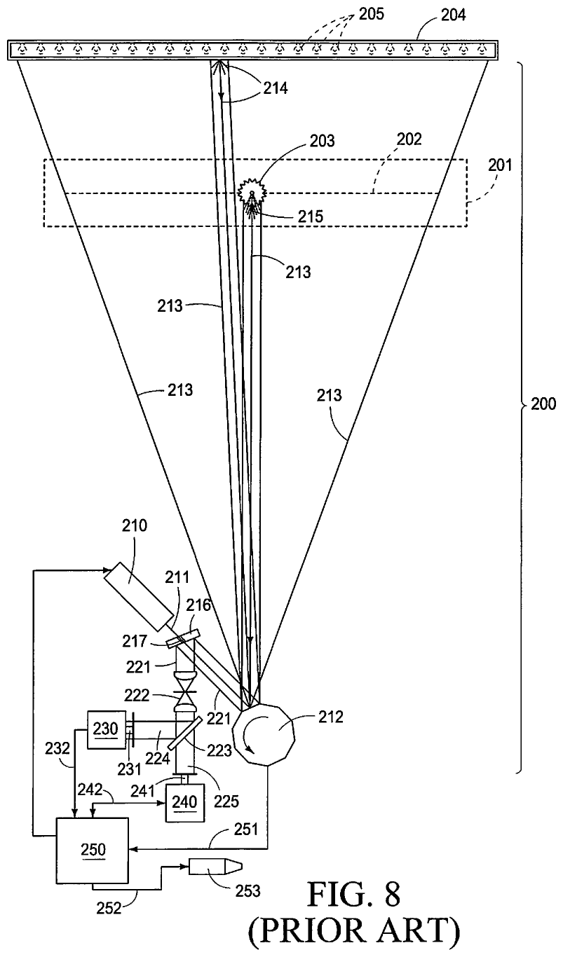

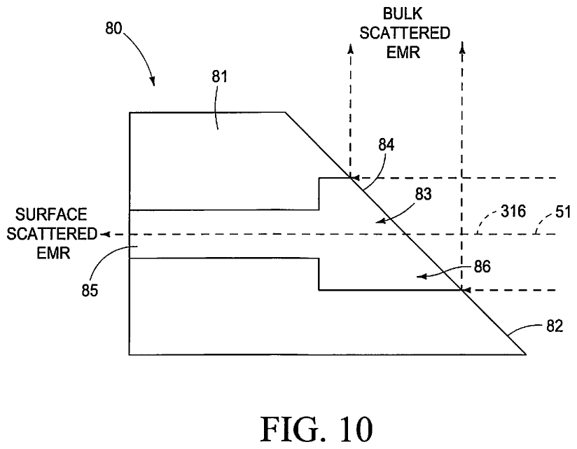

Referring now to FIGS. 5,6, and 10 it will be seen that an optical scattering mirror 80 is provided which is positioned within the first region 34 of the internal cavity 33. Still further it will be recognized that the optical scattering 80 is positioned along the first predetermined line of reference 51, as earlier described. The optical scattering mirror which is positioned or releasably secured within the first region 34 has a main body 81, and which is defined, at least in part, by a predetermined angled, and highly reflective mirror surface 82, and which is further located along the first predetermined line of reference 51. As should be understood from a study of the drawings, an aperture or other optical passageway 83 is formed in the main body 81, and further extends therethrough. The aperture or optical passageway 83 has a first end 84, and an opposite, second end 85. As seen in FIG. 6, it will be recognized that the first end 84 of the aperture or optical passageway 83 normally will have an elliptical shape in view of the angular orientation of the reflective surface 82. As further understood by a study of FIG. 10, the first end of the optical passageway 83 has a first cross-sectional dimension, or area, which effectively operates as an obscuration 86 for the present invention. Further, the cross-sectional dimension or area of the second end 85 of the optical passageway 83 is less than that of the first end 84. The aperture 83 is coaxially aligned with a common, return, electromagnetic radiation signal path, as will be discussed, hereinafter, by using the selectively adjustable base plate 11, as earlier described. From a study of FIGS. 5 and 6 it will be understood that the optical scattering mirror is spatially oriented and aligned by the spatial adjustment of the housing 30 so as be located in the focal plane of the respective electromagnetic radiation detectors which will be described in further detail, below. Further the mirror surface 82 may further be optionally provided with optical coatings which are operable to select for given colors or other optical characteristics of a source of transmitted or reflected electromagnetic radiation which is received by the invention 10 from an inspection zone, for example. As can be appreciated by a study of FIG. 10, the mirror surface 82 operates to effectively reflect bulk scattered electromagnetic radiation (EMR), and the shape of the optical passageway 83 operates to pass surface scattered EMR. The shape of the optical passageway 83 operates to eliminate several prior art optical elements used in prior art devices, and arrangements such as illustrated in FIG. 8, and which further required tedious optical alignment in order to render them operational.

Referring still to FIG. 5 and FIG. 6, respectively, it will be understood that a commercially available, cube-shaped, polarizing beam splitter 90 is optimally positioned within the second region 35, of the internal cavity 33, of the housing 30. The beam-splitter is of conventional design. As will be recognized by a study of FIG. 6, a fastener 91 is provided, and which further secures the beam-splitter 90 in a fixed location within the second region 35, of the internal cavity 33. Still further, it will be recognized that the beam-splitter 90 is also positioned therealong the first, predetermined line of reference 51, and is therefore, coaxially oriented relative to the aforementioned first plate polarizer 65, and band pass filter 72, as earlier discussed.

As further seen in FIGS. 5 and 6, it will be recognized that first and second lens cavities 101 and 102, respectively, are individually formed in predetermined locations in the third, outwardly facing sidewall surface 44, and the second, outwardly facing sidewall surface 43. These first and second lens cavities 101 and 102, respectively, each receive an O-ring seal 103 therein. Still further, first and second ball lenses 104 and 105, respectively, are individually received, at least in part, within the respective first and second lens cavities 101 and 102, respectively. It will be recognized that the first ball lens 104 is positioned therealong the first predetermined line of reference 51. This orientation of the ball lens along the first predetermined line of reference 51 causes it to be positioned in coaxial alignment with the cube-shaped, polarizing beam-splitter 90. It will also be recognized that the second ball lens 105 is positioned laterally, outwardly relative to the first predetermined line of reference 51, and is further oriented in optical receiving relation relative to the polarizing beam-splitter 90. The second ball lens 105 is further oriented along the third, predetermined line of reference 53, as earlier described. As earlier mentioned the third, predetermined line of reference 53 is positioned in a perpendicular orientation relative to the first predetermined line of reference 51.

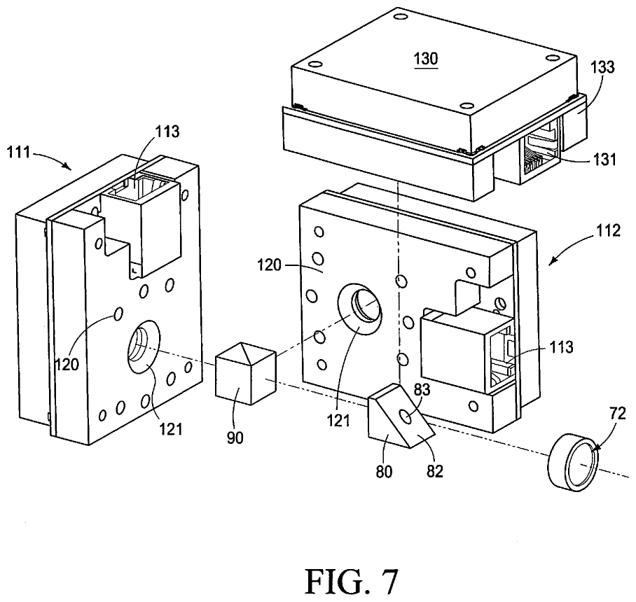

As best seen in FIGS. 5 and 6, a first electromagnetic radiation detector 111 is mounted on, or borne by the housing 30 of the electromagnetic radiation detector assembly 10. The first electromagnetic radiation detector 111 is coaxially oriented relative to the aperture or optical passageway 83, and which is formed in the optical scattering mirror 80. The first electromagnetic radiation detector 111 is rendered operable to detect a given polarization of the surface scattered electromagnetic radiation which is received by the optical scattering mirror 80. This feature of the invention 10 will be discussed in greater detail, hereinafter. Further, a second electromagnetic radiation detector 112 is mounted on the second, outwardly facing sidewall surface 43 of the housing 30. The second, electromagnetic radiation detector 112 is oriented in optical receiving relation relative to the cube-shaped, polarizing beam-splitter 90, and along the third, predetermined line of reference 53. As should be understood, the first, electromagnetic radiation detector 111 is oriented along the first predetermined line of reference 51, and is further disposed in optical receiving relation relative to the cube-shaped polarizing beam-splitter 90. The first, electromagnetic radiation detector 111 is mounted on the third, outwardly facing sidewall surface 44. As should be understood by a study of the drawings, each of the first and second electromagnetic radiation detectors 111 and 112, respectively, have an electrical coupler 113, and which allows the respective electromagnetic radiation detectors to electrically communicate with a controller, as will be discussed, hereinafter. The first and second electromagnetic radiation detectors 111 and 112 operate in a conventional manner so as to generate a predetermined electrical signal, as described hereinafter, and which is subsequently processed and then interpreted by a controller in order to generate a resulting electrical image signal having improved contrast as will be discussed in more detail, hereinafter. Each of the first and second electromagnetic radiation detectors 111 and 112, are mounted on the housing 30, by means of a base plate 120. Each of these base plates 120 has formed therein an optical passageway 121 which allows for the passage of a source of returning electromagnetic radiation, therethrough, so that the returning source of electromagnetic radiation may be received by the sensor 114 which is made integral with each of the first and second electromagnetic radiation detectors 111 and 112, respectively. The passageway 121, which is formed in the individual base plates 120 (FIG. 7), is shaped or otherwise formed, so as to receive, at least in part, a portion of the individual first and second ball lenses 104 and 105, respectively, therein. The respective base plates 120 are attached, or positioned adjacent to, the outside facing exterior surfaces 44 and 43, respectively, of the housing 30, by means of suitable fasteners 122 as seen in FIG. 6.

A third, surface scattered electromagnetic radiation detector 130 is located laterally, outwardly relative to the optical scattering mirror 80, and which further receives a source of bulk scattered electromagnetic radiation coming from the direction of an object of interest, and which further is reflected by the optical scattering mirror 80, and in the direction of the third electromagnetic radiation detector 130. This aspect of the invention will be discussed in greater detail, hereinafter. The third electromagnetic radiation detector 130 includes an electrical coupler 131 which allows the third electromagnetic radiation detector to send, to a controller, electrical signals having improved contrast thereby allowing better sorting decisions to be made, for example, during a sorting operation, and which is being done on a stream of objects of interest passing through an inspection station. The third surface scattered electromagnetic radiation detector 130 further includes a sensor element 132 (FIG. 6) which is oriented in optical receiving relation relative to first region 34, of the internal cavity 33, and which is further defined by the housing 30. As seen in the drawings, the third electromagnetic radiation detector 130 is mounted by suitable threadable fasteners 134, on a sensor mounting plate, and which is generally indicated by the numeral 133. As seen in the drawings the sensor mounting plate 133 has an optical passageway 135 which is formed therein, and which further is disposed in optical receiving relation relative to the first region 34, of the housing 30. It should be understood that the optical passageway 135, which is formed in the sensor mounting plate 133, has a portion 136 which is operable to receive, and otherwise optically cooperate with a third ball lens, as will be discussed, below. The present invention 10 includes an adaptor plate 140, which further has a main body 141, and which further rests on, and is otherwise secured to the top, outwardly facing surface 40, of the housing 30. The adaptor plate 140 defines, at least in part, a lens cavity 142. Still further, an O-ring seal 143 is delivered or positioned in the lens cavity 142. Further a third ball lens 144 is received within the lens cavity 142, and as discussed, above, a portion of the third ball lens 144 is received in and cooperates with the optical passageway 135, and which is further formed in the sensor mounting plate 133. Fasteners 145 are provided, and which secure the adaptor plate 140, bearing the sensor mounting plate 133, to the top, outwardly facing surface 40 of the housing 30. As will be recognized in the transverse, vertical sectional view as illustrated in FIG. 6, the optical scatter mirror 80, third ball lens 144, and the third, surface scattered electromagnetic radiation detector 130 are each disposed in an optimal, fixed, coaxial, optical alignment with each other, and further are positioned along the second, predetermined line of reference 52. As earlier noted the second, predetermined line of reference is oriented substantially perpendicular relative to the first, predetermined line of reference 51. It should be understood that while three (3) electromagnetic radiation sensors 111,112 and 130 are illustrated in the drawings which are provided with this application, one possible form of the invention may include a structure where an electromagnetic radiation detector assembly 10 is assembled, and which further eliminates the second electromagnetic radiation detector 112, and the beam splitter 90 which redirects reflected or emitted electromagnetic radiation coming from the direction of an inspection station, for example, to the second electromagnetic radiation detector 112.

Referring now to FIG. 8, of the drawings, a prior art sorting device or machine 200 which may be utilized to sort a stream of objects of interest, and which could benefit from the present invention 10, is shown. In this highly simplified, schematic drawing, many surfaces and structures are removed in order to show the major subassemblies or components used in such sorting machines or devices 200 which may find a benefit in employing the present invention 10. The sorting device and machine 200 defines, at least in part, an inspection station 201, and which is graphically depicted by dotted lines, and through which a line-of-sight 202 is established. Through this inspection station 201, and along the line of sight 202, a stream of objects of interest 203 pass therethrough. The objects of interest 203 typically move under the influence of gravity during the sorting process. As illustrated in FIG. 8, the objects to be sorted, or objects of interest 203, typically move through the inspection station, and along the line of sight in a path which moves perpendicularly, downwardly through the line of sight, as depicted in this drawing. As seen in FIG. 8, a background element 204 is provided, and which presents, or otherwise creates, a uniform, and typically contrasting background color which allows a subsequent electronic image to be developed of the object of interest 203, when an electrical signal is formed by the operation of the present invention. This image signal is then later processed to form an electrical image which can then be acted upon by a controller, as will be discussed, below. As will be appreciated from a study of the drawings, the background element 204, which is provided, may be solely fabricated as a passive background, that is, it merely reflects light (electromagnetic radiation) impacting and reflected from its exterior facing surface; or in a second, possible form of the invention 205, the background element may be considered an active background, and wherein it may be illuminated, in whole, or in part, by various selectively energized illuminators positioned within the internal cavity of the background element 205 (all shown in hidden lines), and therefore generates a source of electromagnetic radiation which is projected in a direction towards the prior art electromagnetic radiation detectors as will be discussed, below.

The prior art sorting device or machine 200, as seen in FIG. 8, and which could gain benefits from employing the invention 10 includes a source of electromagnetic radiation 210, here depicted as a single, selectively energizable laser. The laser 210 produces a beam of electromagnetic radiation 211, and which is then directed toward a rotating laser scanning mirror 212, as depicted. The source of electromagnetic radiation 211, or laser beam, is then reflected by the rotating laser scanning mirror in a direction towards the inspection station 201, and the background element 204. The rotation of the laser scanning mirror causes the beam of electromagnetic radiation 211 to move back and forth along the length of the inspection station 201, and along the length of the background element 204. The result of this projection or transmission of the source of electromagnetic radiation or laser beam 211 results in reflected background scattered electromagnetic radiation 214, and surface scattered electromagnetic radiation coming from the object of interest 203, and being reflected back in the direction of the rotating laser scanning mirror 212. As will be understood from a study of the drawings, a Pritchard mirror 216, is provided, and which further is positioned therebetween the source of electromagnetic radiation 210, and the rotating laser scanning mirror 212. The Prichard mirror defines a passageway 217, and through which the laser beam or source of electromagnetic radiation 211 passes so that the laser beam may be reflected in the direction of the inspection station 201, and the background element 204. The passageway 214 of the Prichard mirror 216 has a uniform cross-sectional dimension when measured along its entire length. The reflected background scattered electromagnetic radiation 214, and surface scattered electromagnetic radiation 215 coming from the object of interest 203 then returns, and is reflected by the rotating laser scanning mirror 212, back in the direction of the Pritchard mirror 216. The Pritchard mirror 216 then reflects the returning background and surface scattered electromagnetic radiation 221 in a direction towards a beam-shaping optical arrangement 222. It is also important to note that the aforementioned Pritchard mirror 216 does not pass returning electromagnetic radiation coming from the inspection station 201 to an electromagnetic radiation sensor. Rather the Pritchard mirror 216 only allows a source of generated electromagnetic radiation to pass through the Pritchard mirror 216, and which then travels in the direction of the inspection station 201. The aforementioned beam-shaping optical arrangement 222 then optically treats or processes the reflected electromagnetic radiation 221 coming from the Pritchard mirror in a manner so that it may be properly focused, and then directed towards a fractional, optical beam-splitter 223. The optical beam-splitter 223 is well known, and may also have a dichroic coating applied thereto, and which operates so as to allow the passing of predetermined bands of returning electromagnetic radiation, and the reflection of other bands of electromagnetic radiation. The fractional beam-splitter 223 subsequently forms a first beam of electromagnetic radiation 224, and a second beam of electromagnetic radiation 225. The first beam of electromagnetic radiation 224 is directed towards a bulk scattered electromagnetic radiation detector, and which is generally indicated by the numeral 230. The bulk scattered electromagnetic radiation detector 230 has an aperture 231, and which may have a given, central obscuration (not shown), and which allows for the detection of the bulk scattered electromagnetic radiation coming from a location, such as the background element 204. On the other hand, the second beam of electromagnetic radiation 225, and which has passed through the fractional beam-splitter is received by a surface scattered electromagnetic radiation detector 240. The second or surface scattered electromagnetic radiation detector 240, similarly has an aperture 241, and which allows for the collection of the amount of surface scattered electromagnetic radiation needed to produce an electrical signal 242. An electrical signal 232, and which is formed or produced by the bulk scattered electromagnetic radiation detector 230, and the electrical signal 242 provided or produced by the surface scattered electromagnetic radiation detector 240 are both provided to a controller 250. The precise spatial orientation, and optical alignment of the apertures 231 and 241 in the prior art machine 200 as illustrated in FIG. 8 has been achieved, heretofore, through the use of opto-mechanical mounts of assorted designs, and which are further time consuming to use. As will be appreciated by those skilled in the art, even a very small amount of misalignment of the aforementioned apertures results in a rather significant degradation of any sorting machine 200 which is equipped in this manner. The controller 250 then takes and receives the electrical signals 230 and 240, and then process these same signals into images which are then utilized by the controller to determine whether the object of interest 203 has acceptable features or unacceptable features from a sorting perspective. The controller 250 is well known in the art. The controller 250 then produces a controller signal which operably controls each of the electromagnetic radiation detectors 230 and 240, respectively, as well as receives the electrical signals 232 and 242, respectively. Still further, the controller 250 provides a signal 251 which operably controls the speed of rotation of the rotating laser scanning mirror 212 so that a determination can be made as to the location of the object of interest 203 along the line of sight 202. In the event that the controller 250 identifies an object of interest having undesirable characteristics the controller can then send a control signal 252 to a prior art pneumatic ejector, 253, and which can be then used to remove the undesirable object of interest 203 from a product stream passing through the inspection station 201, and which was discussed, above.

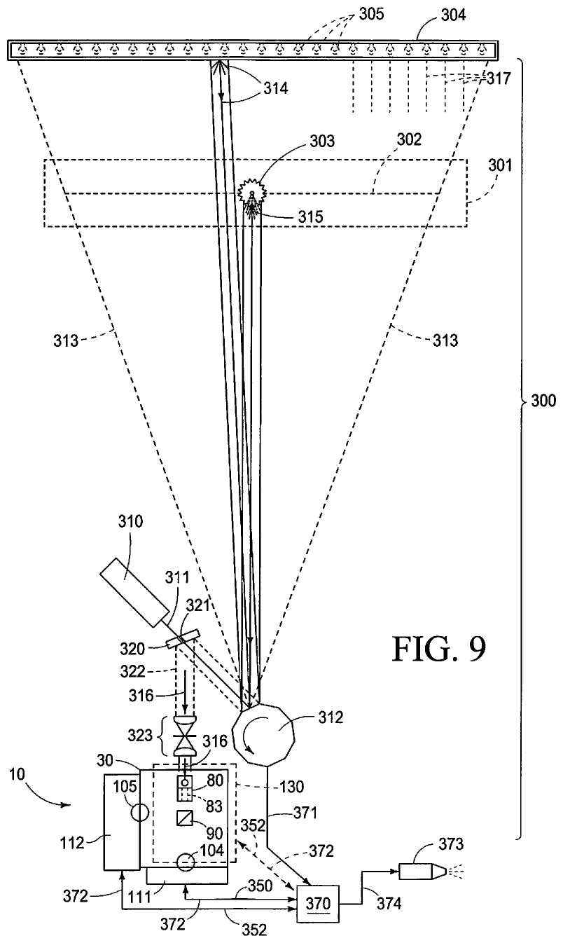

As will be appreciated from a study of the drawings (FIGS. 8 and 9), the present invention 10 provides a means to substantially replace many of the components as seen in FIG. 8, and in particular the bulk and surface scattered electromagnetic detectors 230 and 240, respectively. In particular, and as discussed, above, the respective detectors 230, and 240 were individually, mounted in a prior art machine 200, and then individually adjusted so as to provide an optimal optical alignment which was effective to achieve the benefits of that prior art arrangement. However, the present invention provides a single assembly, as depicted in FIG. 1, for example, and which can be precisely spatially oriented so as to receive the reflected bulk and/or surface scattered electromagnetic radiation returning from the direction of the inspection station 201, in a novel way, so that the resulting electromagnetic radiation detectors 111, 112, and 130, as earlier described, can selectively detect, with an improved signal-to-noise ratio, the bulk scattered electromagnetic radiation, the surface scattered electromagnetic radiation and/or another source of electromagnetic radiation coming from the direction of an object of interest, such as what is generated by an energized background element, and then generate resulting image signals having improved contrast. This novel arrangement improves the sorting efficiency, and reliability of a sorting machine employing same. The use of the present invention 10 is schematically represented in FIG. 9, and will be discussed in greater detail in the paragraphs which follows.

Referring now to FIG. 9, a sorting device, or machine 300, and which incorporates the present invention 10 is seen in this very simplistic schematic diagram. Similar to the prior art device as seen in FIG. 8, the sorting device 300 which incorporates the present invention includes an inspection station 301, and which is graphically depicted by dotted lines, and through which a line of sight 302 is established through this same inspection station 301. Along the line of sight 302 a stream of objects of interest 303 pass therethrough. The objects of interest 303 typically move under the influence of gravity, as earlier described, during a predetermined sorting process. As illustrated in this view, the objects to be sorted, or objects of interest 303, typically move through the inspection station 301, and along the line of sight 302, and further in a path which is typically perpendicularly, downwardly oriented relative to the line of sight as depicted in this drawing. As seen in this same view, a background element 304 is provided, and which presents, or otherwise creates, a uniform, and typically contrasting background color which allows a subsequent electronic image to be developed of the object of interest 303 when an electrical signal is formed by the operation of the present invention 10. This image signal is then processed to form an electrical image which can then be acted upon by a controller as will be described, below. As will be appreciated from a study of this drawing the background element 304, which is provided, may be solely fabricated as a passive background, that is, it merely reflects electromagnetic radiation impacting and then reflected from its exterior surface; or in a second, possible form of the invention 305, the background element may be considered an active background, and wherein the active background may be illuminated, in whole, or in part, by various selectively energized illuminators which are usually positioned within the internal cavity of the background element 305 (all shown in hidden lines), and therefore generates a source of electromagnetic radiation 317, and which is then projected in a direction towards the present invention 10, as will be discussed, below. The sorting device 300 incorporating the present invention 10 further includes a source of electromagnetic radiation 310, here depicted as a single, selectively energizable laser. Still further, the laser 310 produces a beam of electromagnetic radiation 311, here depicted as being directed towards a rotating laser scanning mirror 312. The source of electromagnetic radiation 311, or laser beam, is then reflected by the rotating laser scanning mirror 312 in a direction towards the inspection station 301, and the background element 304. The rotation of the laser scanning mirror 312 effectively causes the beam of electromagnetic radiation 311 to move, back and forth, along the length of the inspection station 301 and along the length of the background element 304. The result of this transmission of the source of electromagnetic radiation or laser beam 311 results in reflected bulk, background scattered electromagnetic radiation 314, and surface scatter electromagnetic radiation 315, which is then reflected from the object of interest 303 back in the direction of the rotating laser scanning mirror 312, and along a common, electromagnetic radiation signal path 316, as seen in FIG. 9. As earlier noted, electromagnetic radiation 317 which is generated by an energized, active background 305 constitutes another, second, possible source of electromagnetic radiation coming back in the direction of the present invention 10.

Similar to what was discussed with regard to the prior art device 200, as seen in FIG. 8, the present sorting device 300 incorporating the invention 10, and which is seen in FIG. 9, incorporates a Prichard mirror 320 which is oriented between the source of electromagnetic radiation 310, and the rotating laser scanning mirror 312. The Prichard mirror 320 has an aperture 321 formed therein, and which permits the laser beam 311 which is generated by the source of electromagnetic radiation 310 to pass therethrough, and then be reflected from the rotating laser scanning mirror 312. Similar to the prior art device as seen in FIG. 8, the reflected background scattered electromagnetic radiation 314, and surface scattered electromagnetic radiation 315, coming from the direction of the object of interest 303, returns and is reflected by the laser scanning mirror 312 back in the direction of the Prichard mirror 320. The Prichard mirror 320 then reflects the returning background and surface scattered electromagnetic radiation 322 in a direction towards a conventional beam-shaping optical arrangement 323. Again, in this form of the present invention it should be recognized that the Prichard mirror 320 only allows a source of generated electromagnetic radiation 311 to pass through the Prichard mirror 320, and which then travels in the direction of the inspection station 301. The aforementioned beam-shaping optical arrangement 323 then optically treats or processes the reflected electromagnetic radiation 322 coming from the direction of the Prichard mirror 320 in a manner so that returning electromagnetic radiation may be properly focused, and then directed along the common electromagnetic radiation signal path 316, and which is further coaxially aligned with the first, predetermined line of reference 51. As earlier discussed the electromagnetic radiation traveling back in the direction towards the present invention 10, and along the common electromagnetic radiation signal path then enters into the housing 30, by first passing through the band pass filter 72. The electromagnetic radiation passed by the band pass filter 72 is then passed, at least in part, and reflected, at least in part by the optical scattering mirror 80 as seen in FIG. 10. As earlier discussed, the aperture, or optical passageway 83 which is formed in the optical scattering mirror 80 is effective to simultaneously reflect, at least in part, bulk scattered electromagnetic radiation, and pass, at least in part, surface scattered electromagnetic radiation in a manner such that the associated electromagnetic radiation detectors 111, 112 and 130, respectively, can then form resulting electrical signals having improved contrast. The unique and novel shape, and function of the optical scanning mirror 80, simultaneously operates as an aperture for both the electromagnetic radiation detectors 111, 112 and 130, respectively, and thereby eliminates the need for precise positioning of the apertures of the prior art devices, as earlier discussed. Therefore, precise alignment and/or periodic realignment of these apertures is no longer necessary. It should be clear that the present invention removes a significant problem confronting the prior art devices utilized, heretofore. Alignment of the present invention merely includes an adjustment of the selectively adjustable baseplate 11, in either the vertical or horizontal plane 19 or 18, so as to precisely orient the common electromagnetic radiation signal path 316 with the first, predetermined line of reference 51 which extends into the first region 34 of the internal cavity 33. As earlier discussed, the optical scattering mirror 80 is positioned in the first region 34. Once this alignment of the optical passageway 83 is performed the first, second and third electromagnetic radiation detectors 111, 112 and 113, respectively, are automatically, and in unison, precisely oriented so as to optimally function.

The first, second and third electromagnetic radiation detectors 111, 112, and 130, respectively, each generate an electrical image signal 350, 351 and 352 respectively. These signals are in response to the bulk and/or surface scattered electromagnetic radiation received by their respective electromagnetic radiation sensors. These respective electrical signals 350, 351 and 352, respectively, are each supplied to a controller 370, and which then takes these same electrical signals and then processes them into electrical images which are then utilized by the controller 370 to determine whether the object of interest 303 has acceptable features, or unacceptable features, from a sorting perspective. The controller 370 is well known in the art, and further produces a controller signal 372 which operably controls each of the electromagnetic radiation detectors 111, 112, and 130. Still further the controller 370 receives and provides electrical signals 371 from or to the laser scanning mirror 312, and which operably controls the speed of rotation of the rotating laser scanning mirror 312 so that a determination can be made by the controller 370 as to the location of any object of interest 303, and which is moving along the line of sight 302. Similar to the prior art device 200, in the event the controller 370 identifies an object of interest having undesirable characteristics, the controller 370 can then send a control signal 374 to a prior art pneumatic ejector 373, and which can then be used to remove any undesirable object of interest 303 from a product stream passing through the inspection station 301, and which was discussed, above.

The present invention 10, as described, above, also relates to a method for detecting an object of interest 303, as earlier described. In this regard, the methodology includes a first step of providing a source of electromagnetic radiation 310, and directing the source of electromagnetic radiation 310 toward an object of interest 303 to be detected, and which is further optically scattered from the object of interest in bulk 314, and/or from a surface thereof 315, and which further travels in a direction away from the object of interest 303, along a common, return, electromagnetic radiation signal pass 316. This methodology includes another step of providing a housing 30, and positioning the housing 30 along the common, electromagnetic radiation signal path 316, and further defining within the housing 30, an internal cavity 33, having a first and second discreet regions 34 and 35, respectively. The methodology as shown in the attached drawings further includes a step of positioning an optical scattering mirror 80 in a non-perpendicular orientation relative to the common, electromagnetic radiation signal path 316, and within the first region 34, of the internal cavity 33. This step includes another step of forming a predetermined aperture 83, in the optical scattering mirror 80, and which further extends therethrough. The methodology of the present invention includes another step of positioning an optical beam-splitter 90, within the second, discreet region 35 of the internal cavity 33, of the housing 30, and in an optical receiving relationship relative to the predetermined aperture 83, and which is formed in the optical scattering mirror 80. The method of the present invention includes another step of positioning a first electromagnetic radiation detector 111, on the housing 30, and then orienting the first electromagnetic radiation detector 111 in an optical receiving relationship relative to the optical beam-splitter 90. The optical scattering mirror 80, optical beam-splitter 90, and the first, electromagnetic radiation detector 111 are co-axially oriented relative to the common, electromagnetic radiation signal path 316. The method of the present invention includes another step of positioning a second, electromagnetic radiation detector 112 on the housing 30, and then orienting the second, electromagnetic radiation detector 112 in an optical receiving relationship relative to the optical beam-splitter 90, and laterally, outwardly, relative to the common, electromagnetic radiation signal path 313. The methodology of the present invention includes another step of positioning a third, electromagnetic radiation detector 130 on the housing 30, and then orienting the third, electromagnetic radiation detector 130 in an optical receiving relationship relative to the optical scattering mirror 80, and which is further located in the first discreet region 34 of the internal cavity 30, and laterally, outwardly, relative to the common electrical signal path 316. The method includes another step, and wherein the housing, optical scattering mirror 80, optical beam-splitter 90, and first and second and third electromagnetic radiation detectors 111, 112 and 130 respectively, in combination, form the electromagnetic radiation detector assembly 10. Finally, the present methodology includes a step of adjustably positioning, by means of the adjustable base plate 11, the electromagnetic radiation detector assembly 10 in a predetermined vertical and horizontal orientation 18 and 19, respectively, so as to orient, in unison, the optical scattering mirror 80; optical beam-splitter 90; and first, second, and third electromagnetic radiation detectors 111, 112 and 130, respectively, in an optimal position so as to selectively detect, with an improved signal-to-noise ratio, the bulk scattered electromagnetic radiation 314; the surface scattered electromagnetic radiation 315; and/or another source of electromagnetic radiation 317, such as the electromagnetic radiation being generated by an energized background 305, and then generating image signal 350, 351, and 352, respectively, having improved contrast.

The methodology of the present invention includes another step of positioning an optical band pass filter 72, on the housing 30, and then mounting the optical band pass filter 72 in an optical transmitting relationship relative to the optical scattering mirror 80, and further optically transmitting with the optical band pass filter 72 the source of electromagnetic radiation 310 which is optically scattered 314, and 315, at least in part, from the object of interest 303; and/or from a surface of the background element 304, into the first discreet region 34, of the internal cavity 33, and to the optical scattering mirror 80 which is located within the first discreet region 34, of the internal cavity 33. The method of the present invention includes another step, and wherein the step of forming the aperture 83 in the optical scattering mirror 80 further comprises forming the aperture 83 having a given shape; and orienting the optical scattering mirror 80 in a predetermined, non-perpendicular orientation relative to the common electromagnetic radiation signal path 316. This step further includes correlating the given shape of the aperture 83 with the predetermined, non-perpendicular orientation of the optical scattering mirror 80 as measured relative to the common, electromagnetic radiation signal path 316. This step further includes another step of positioning the aperture 83, having the given shape, along the common, electromagnetic radiation signal path 316 by adjusting the horizontal and vertical positions 18 and 19, respectively, of the housing 30. The method of the present invention includes another step of positioning a first lens 104, at least in part, within a third discreet region 36 which is defined by the internal cavity 33, of the housing 30, and positioning the first lens 104, in an optical receiving relationship relative to the optical beam-splitter 90, and in an optical transmitting relationship relative to the first electromagnetic radiation detector 111. The present methodology includes another step of positioning a second lens 105, at least in part, within a fourth discreet region 37, and which is defined by the internal cavity 33, of the housing 30, and positioning the second lens 105 in an optical receiving relationship relative to the optical beam-splitter 90, and in an optical transmitting relationship relative to the second, electromagnetic radiation detector 112. The present methodology includes another step of positioning a third lens 144 in an optical receiving relationship relative to the optical scattering mirror 80, and further in an optical transmitting relation relative to the third, electromagnetic radiation detector 130. The method of the present invention includes still another step of providing a first optical polarizing lens 65, and positioning the first optical polarizing lens on the housing 30, and further orienting the first optical polarizing lens in a spaced, optical receiving relationship relative to the optical band pass filter 72, and further positioning the first optical polarizing lens 65, in an optical transmitting relationship relative to the first discreet region 33 of the cavity 30 as defined by the housing 30, and along the common, electromagnetic radiation signal path 316. The method of the present invention includes still another step of providing a second optical polarizing lens 66, and which is positioned on the housing 30, and further orienting the second, optical polarizing lens 66 in an optical receiving relationship relative to the first, discreet region 34, of the internal cavity 33, of the housing 30, and the optical scattering mirror 80, which is positioned within the second discreet region of the housing 30. The method includes still another step of positioning the second optical polarizing lens 66 in an optical transmitting relation relative to the third lens 130, and simultaneously orienting the optical scattering mirror 80; second optical polarizing lens 60; third lens 144 and third electromagnetic radiation detector 130 along a predetermined line of reference 52 which is oriented in a perpendicular relationship relative to the common electromagnetic radiation signal path 316, and a line of reference 51.

### Operation

The operation of the described embodiments of the present invention are believed to be readily apparent, and are briefly summarized in the paragraphs which follow.

In its broadest aspect, the present invention relates to an electromagnetic radiation detector assembly 10 which includes a source of electromagnetic radiation 310 which is directed at an object of interest 303, as seen in FIG. 9, and which is further scattered, at least in part, from the object of interest 303, in bulk 314, and/or from a surface thereof 315, and which further moves, or travels in a direction towards the electromagnetic radiation detector assembly 10. In its broadest aspect the present invention includes an optical scattering mirror 80, which is made integral with the electromagnetic radiation detector assembly 10, and which further simultaneously, optically interacts with the source of the bulk 314, and/or surface scattered electromagnetic radiation 315 which is coming from the direction of the object of interest 303, and which are being imaged and sorted, so as to function, at least in part, as a bulk scattered, and/or a surface scattered spatial input filter. Still further, and in its broadest aspect, the present invention includes individual electromagnetic radiation detectors 111, 112, and 130, respectively, and which are made integral with the electromagnetic radiation detector assembly 10. The respective electromagnetic radiation detectors are further spatially oriented in fixed, predetermined locations relative to the optical scattering mirror 80 so as to selectively detect, with an improved signal-to-noise ratio, the bulk scattered electromagnetic radiation 314; the surface scattered electromagnetic radiation 315; and/or another source of electromagnetic radiation 317 which comes from the direction of the object of interest 303, and which then generates a resulting image signals 350, 351 and 352, respectively, having improved contrast.

The present invention 10, as described, above, includes a housing 30 which defines an internal cavity 33, and which further encloses the optical scattering mirror 80. The housing 30 further mounts the individual electromagnetic radiation detectors 111, 112 and 130 respectively on given exterior facing surfaces thereof. The housing 30 which carries the respective optical scattering mirror 80, and the individual electromagnetic radiation detectors, as described, above, is selectively movably adjustable in both a predetermined horizontal, and vertical planes 19, and 18, respectively. The present invention 10, and more specifically the source of electromagnetic radiation 310 includes a narrow beam of electromagnetic radiation which includes one or more predetermined bands of electromagnetic radiation. The other source of electromagnetic radiation 317 coming from the direction of the object of interest 303 is typically generated, at least in part, by a selectively energizable background element 305 (Shown in hidden lines in FIG. 9).

The present invention 10, and more specifically the electromagnetic radiation 310 as described, above, and which includes bulk and/or surface scattered electromagnetic radiation 314 and 315, respectively, and which comes from the direction of the object of interest 303, each share a common, return, electromagnetic radiation signal path 316. As should be apparent by studying FIGS. 5 and 6, the optical scattering mirror 80 is oriented along the common electromagnetic radiation signal pass 316. The first, predetermined line of reference 51, and the common electromagnetic radiation signal path 316, are coaxially aligned. As seen in the drawings, at least one of the individual electromagnetic radiation detectors 112 and 130, respectively, and which are made integral with the electromagnetic radiation detector assembly 10, is oriented in a spaced, laterally, outwardly disposed relationship relative to the common electromagnetic radiation signal path 316. Still further, at least one of the individual electromagnetic radiation detectors 111 is coaxially aligned relative to the common electromagnetic radiation signal path 316. As will be recognized from a study of the drawings, the optical scattering mirror 80 is optimally, and operationally coaxially aligned relative to the common, electromagnetic radiation signal path 316 by movably adjusting the spatial position of the housing 30 in the horizontal and vertical planes 19 and 18, respectively, relative to the common, return electromagnetic radiation signal path 316. This is achieved by the threadable advancement of the respective threaded bolts 17. As should be recognized, by the aforementioned means, all the electromagnetic radiation detectors 111, 112 and 130 move in unison, therefore the optical alignment of these specific detectors with the optical scattering mirror 80 is not compromised.

In the arrangement as seen in the drawings, it will be recognized that the optical scattering mirror 80 has a polygonal or block shaped main body 81, and which defines one angled, and planar mirror or reflective surface 82. The reflective surface 82 is oriented in a non-perpendicular, and at least a partially reflecting orientation relative to the common, electromagnetic radiation signal path 316. The optical scattering mirror 80 reflects, at least in part, and passes, at least in part, the scattered electromagnetic radiation 314 and 315, and/or other electromagnetic radiation 317, coming from the direction of the object of interest 303, and in the direction of at least one of the electromagnetic radiation detectors 111, 112 and 130, respectively.

As will be appreciated from a study of the drawings, the optical scattering mirror 80 has an aperture 83 formed in a predetermined location therein, and which extends therethrough. The aperture 83 which is formed in the optical scattering mirror 80 is substantially coaxially aligned with the common, electromagnetic radiation signal path 316 by the adjustment of the position of the housing 30, by utilizing the adjustable base plate 11. The optical scattering mirror 80 is located between the object of interest 303, and at least one of the electromagnetic radiation detectors such as 111, and which is further individually coaxially aligned with the common, electromagnetic radiation signal path 316. In the arrangement as seen in the drawings, the aperture 83, which is formed in the optical scattering mirror 80 has a given shape which is correlated with the predetermined non-perpendicular orientation of the optical scattering mirror 80, as measured relative to the common, electromagnetic radiation signal path 316. In one possible form of the invention, the aperture 83 which is formed in the optical scattering mirror 80 includes a centrally disposed obscuration 86 which renders the optical scattering mirror 80 optically effective to function as a bulk scattered spatial input filter for the electromagnetic radiation 314, 315, and 317, respectively, and which comes from the direction of the object of interest 303. As also seen in the drawings, the aperture 83, which is formed in the optical scattering mirror 80, as illustrated, is non-occluded, and which further renders the optical scattering mirror 80 effective to function as a surface scattered spatial input filter for the electromagnetic radiation 314, 315 and 317, respectively, and which further comes from the direction of the object of interest 303. As seen in FIG. 10 the optical passageway 83, and which is formed in the optical mirror 80, has a variable, cross-sectional dimension which is effective to operate as both a bulk and surface scattered spatial input filter, simultaneously, for the present invention.

The present invention 10 further includes an optical filter 72, and which is mounted on the housing 30, and which further operates to optically select, and then optically pass surface scattered electromagnetic radiation 315 having a predetermined polarization, and which is coming from the direction of the object of interest 303, or the background element 304, for example. The aperture 83 which is formed in the optical scattering mirror 80, and as seen in the drawings, is non-occluded, and which further renders the optical scattering mirror 80 operable to function as a polarized, surface scattered spatial input filter for the electromagnetic radiation 314, 315 and 317, respectively, and which comes from the direction of the object of interest 303. In the arrangement as seen in the drawings, the optical filter 72 having the predetermined polarization optically selects, and then optically passes vertically oriented, surface scattered electromagnetic radiation 315. In another possible form of the invention, the optical filter having the predetermined polarization optically selects, and then optically passes horizontally oriented surface scattered electromagnetic radiation 315.

In one possible form of the invention, the electromagnetic radiation detector assembly 10 has at least one electromagnetic radiation detector 111, 112, or 130 which functions as a bulk scattered electromagnetic radiation detector, and which further is coaxially oriented relative to the aperture 83, and which is further formed in the optical scattering mirror 80. The aperture 83 receives, and then optically passes, the bulk scattered electromagnetic radiation 314 which comes from the direction of the object of interest 303. Still further, and in another possible form of the invention, a surface scattered electromagnetic radiation detector is located laterally, outwardly, relative to the optical scattering mirror 80, and which further receives the surface scattered electromagnetic radiation 315 from the direction of the object of interest, and which is further reflected by the optical scattering mirror 80, and in the direction of the surface scattered electromagnetic radiation detector, as provided.

In another possible form of the invention at least one of the electromagnetic radiation detectors 111, 112 and 130, respectively operates as a surface scattered electromagnetic radiation detector which is coaxially oriented relative to the aperture 83 which is formed in the optical scattering mirror 80, and which further receives, and then optically passes the surface scattered electromagnetic radiation which comes from the direction of the object of interest 303. Still further a bulk scattered electromagnetic radiation detector is located laterally outwardly relative to the optical scattering mirror 80 and which further receives the bulk scattered electromagnetic radiation coming from the direction of the object of interest 303, and which is further reflected by the optical scattering mirror 80 in the direction of the bulk scattered electromagnetic radiation detector. In another possible form of the invention an electromagnetic radiation polarizer detector 65 and 66, respectively, are provided and which are borne by the housing 30 of the electromagnetic detector assembly 10. The electromagnetic radiation polarizer detector 65 is further coaxially oriented relative to the non-occluded aperture 83, and which is formed in the optical scattering mirror 80 so as to detect a given polarization of the surface scattered electromagnetic radiation which is received by the optical scattering mirror 80. In still another possible form of the invention a fluorescent electromagnetic radiation detector may be mounted on the housing 30, and further is positioned in a given orientation relative to the optical scattering mirror 80, and which additionally detects a given fluorescent electromagnetic radiation coming from the direction of the object of interest 303.

More specifically the present invention relates to an electromagnetic radiation detector assembly 10 which includes a selectively adjustable base plate 11 for supporting the electromagnetic radiation detector assembly 10 in a predetermined horizontal, and vertical orientation 19, and 18, respectively. The base plate 11 has an upwardly, and outwardly facing supporting surface 13, and which is further defined, in part, by a peripheral edge 15. The present invention includes a housing 30 having a main body which defines an internal cavity 33. The internal cavity is further defined, in part, by predetermined, first, second, third and fourth regions, 34 through 37, respectively. The housing 30 is further defined, in part, by spaced apart, upper and lower outwardly facing surfaces 40 and 41, respectively, and first, second, third and fourth outwardly facing sidewall surfaces 42 through 45, and which further individually extend between the upper and lower outwardly facing surfaces 40 and 41, of the housing 30. The lower and outwardly facing surface 41, of the housing 30 is mounted on the upwardly, and outwardly facing supporting surface 13, of the selectively adjustable base plate 11. The present invention 10 includes an optical scattering mirror 80 which is mounted in a predetermined spatial, and optical reflecting, and transmitting orientation within the first region 34 of the internal cavity 33, as defined by the housing 30 and which further optically interacts with electromagnetic radiation which comes from the direction of the aforementioned inspection station and toward the electromagnetic radiation detection assembly 10. The optical scattering mirror 80 has an aperture 83 which is formed therein, and which further extends therethrough. The present invention 10 also includes an optical beam splitter 90 which is positioned within the second region 35, of the internal cavity 33, as defined by the housing 30. The optical beam splitter 90 is located in a predetermined, spaced relationship, and in an optical receiving relationship relative to the optical scattering mirror 80. The present invention 10 further includes a first lens 104 which is received, and supported, at least in part, within the third region 36, of the internal cavity 33, as defined by the housing 30. The first lens 104 is positioned in a predetermined, spaced relationship, and in an optical receiving relationship relative to the optical beam splitter 90. The optical scattering mirror 80, optical beam splitter 90, and the first lens 104 are coaxially aligned along a first predetermined line of reference 51, one relative to the other.

The present invention as described in the paragraphs, above, further includes a first electromagnetic radiation detector 111 which is mounted on the third outwardly facing sidewall surface 44 of the housing 30, and which is further oriented in an optical receiving relationship relative to the first lens 104. Still further, the present invention includes a second lens 105 which is received, and supported, at least in part, within the fourth region 37, of the internal cavity 33, as defined by the housing 30. The second lens 105 is positioned in optical receiving relation relative to the optical beam splitter 90, and is further spatially oriented laterally, outwardly, relative to the first predetermined line of reference 51, as defined, at least in part, by the optical scattering mirror 80, optical beam splitter 90, and the first lens 104. The present invention 10 includes a second electromagnetic radiation detector 112 which is mounted on the second, outwardly facing sidewall surface 43, of the housing 30, and which is further oriented in an optical receiving relationship relative to the second lens 105.

The present invention 10 includes a sensor mounting plate 133 having predetermined, spaced, outwardly facing, top and bottom surfaces, and which further defines an optical passageway 135 which communicates with both of the outwardly facing top and bottom surfaces thereof. The outwardly facing bottom surface of the sensor mounting plate 133 is mounted on, or juxtaposed relative to, the upper, outwardly facing surface 40, of the housing 30. The optical passageway 135, which is defined by the sensor mounting plate 133, is oriented in an optical receiving relationship relative to the optical scattering mirror 80. As earlier discussed, the optical scattering mirror 80 is located within the first region 34, as defined by the internal cavity 33, of the housing 30. The present invention 10 also includes a third lens 144 which is received, and supported, at least in part, within the optical passageway 135 as defined by the sensor mounting plate 133. The third lens 144 is oriented in an optical receiving relationship relative to the first region 34, of the internal cavity 33, as defined by the housing 30. The present invention as seen in the drawings also includes a third, electromagnetic radiation detector 130 which is mounted on the top, outwardly facing surface of the sensor mounting plate 133, and which is further oriented in an optical receiving relationship relative to the third lens 144.

The present invention 10, as described in the paragraphs, above, further includes an optical band pass filter 72 which is mounted in a spaced relationship relative to the first, outwardly facing sidewall 42 of the housing 30, and which is further positioned in an optical transmitting relation relative to the first region 34, of the internal cavity 33, as defined by the housing 30, and is further disposed in spaced relation relative to the optical scattering mirror 80, and which is positioned within the first region 34. The optical band pass filter 72 is further oriented along the first, predetermined line of reference 51. A first, optical polarizing lens 65 is mounted on the first outwardly facing sidewall 42 of the housing 30, and is further oriented in a spaced, optical receiving relationship relative to the optical band pass filter 72. The first optical polarizing lens 65 is further positioned in an optical transmitting relationship relative to the first region 34, of the internal cavity 33, as defined by the housing 30. Still further, the polarizing lens 65 is coaxially oriented relative to the optical scattering mirror 80, and which is positioned within the first region 34. The first optical polarizing lens 65 is further oriented along the first predetermined line of reference 51.

The present invention further includes a second, optical polarizing lens 66 which is mounted on the outside facing, bottom surface of the sensor mounting plate 133, and which is further oriented in an optical receiving relationship relative to the first region 34, of the internal cavity 33, of the housing 30. The second, optical polarizing lens 66 is also oriented in an optical receiving relationship relative to the optical scattering mirror 80, and which is positioned, as discussed, above, within the first region 34, of the housing 30. The second, optical polarizing lens 66 is further positioned in an optical transmitting relationship relative to the third lens 144, and which is further supported, at least in part, within the optical passageway 135, as defined by the sensor mounting plate 133. The optical scattering mirror 80, second, optical polarizing lens 65, third lens 144, and the third electromagnetic radiation detector 130 are each oriented along a second, predetermined line of reference 52 which is oriented in a perpendicular relationship or orientation relative to the first, predetermined line of reference 51.

The present invention 10, as described in the paragraphs immediately, above, is operable to process a source of electromagnetic radiation 310 which is first directed at an object of interest 303, and which is further optically scattered, at least in part, from the object of interest, in bulk 314, and/or from a surface thereof 315, and which further moves in a direction towards the electromagnetic radiation detector assembly 10. As discussed, above, the optical scattering mirror 80 which is made integral with the electromagnetic radiation detector 10 simultaneously interacts with the source of the bulk and/or surface scatter electromagnetic radiation 314 and 315, respectively, and which is coming from the direction of the object of interest 303 or background element 304, so as to function, at least in part, as a bulk scattered, and/or surface scattered spatial input filter. It is important to note that the optical scattering mirror 80 does not function to pass generated electromagnetic radiation which is moving in a direction towards the objects of interest 303, and which are passing through an inspection station as seen in FIG. 9. The first, second, and third electromagnetic radiation detectors 111, 112, and 130, respectively, as earlier described, are made integral with the electromagnetic radiation detector assembly 10, are further spatially oriented in predetermined locations relative to the optical scattering mirror 80, by means of the housing 30, so as to selectively detect, with an improved signal-to-noise ratio, the bulk scattered electromagnetic radiation 314; and surface scatter electromagnetic radiation 315, respectively, and/or another source of electromagnetic radiation 317 coming from the direction of the object of interest 303 or the background element 304, and then generates resulting image signals 350, 351, and 352, respectively, having improved contrast.

Therefore it will be seen that the present invention 10 provides many advantages over the prior art teachings which have been utilized in various sorting devices, and other machines in the past. In particular, the present invention avoids many shortcomings of the prior art inasmuch as the selectively adjustable housing 30 provides a very convenient means by which the electromagnetic radiation detector assembly 10 can be precisely oriented or positioned so as to be placed along the common, return, electromagnetic radiation signal path 316, as illustrated in FIG. 9, so as to achieve the improved contrast, as discussed, above. On the other hand, the prior art teachings as seen in FIG. 8 often required tedious, time consuming alignment of the various electromagnetic radiation sensors in order to achieve the benefits those designs afforded. However, it should be understood that these prior art alignments of various sensors often became difficult to maintain especially if the environment in which sorting devices were exposed experienced wide swings of temperature and/or periodic vibration, during the operation of the sorting machine utilizing same.

In compliance with the statute, the present invention has been described in language more or less specific, as to structural and methodical features. It is to be understood, however, that the invention is not limited to the specific features shown and described since the means herein disclosed comprise preferred forms of putting the invention into effect. The invention is, therefore, claimed in any of its forms or modifications within the proper scope of the appended claims appropriately interpreted in accordance with the Doctrine of Equivalence.

We claim:

1. An electromagnetic radiation detector assembly, comprising:
a source of electromagnetic radiation which is directed at an object of interest, and which is further scattered, at least in part, from the object of interest in bulk, and/or from a surface thereof, and which further moves in a direction towards the electromagnetic radiation detector assembly;
an optical scatter mirror made integral with the electromagnetic radiation detector assembly, and which simultaneously optically interacts with the source of the bulk and/or surface scattered electromagnetic radiation coming from the object of interest so as to function, at least in part, as either a bulk scatter, and/or a surface scatter spatial input filter; and
individual electromagnetic radiation detectors which are made integral with the electromagnetic radiation detector assembly, and which are further spatially oriented in fixed, predetermined locations relative to the optical scatter mirror, so as to selectively detect, with an improved signal-to-noise ratio, the bulk scattered electromagnetic radiation; the surface scattered electromagnetic radiation; and/or another source of electromagnetic radiation coming from the direction of the object of interest, and then generate a resulting image signal having improved contrast.

2. An electromagnetic radiation detector assembly as claimed in claim 1, and further comprising:
a housing defining an internal cavity and which further encloses the optical scatter mirror, and the individual electromagnetic radiation detectors, and wherein the housing carrying the respective optical scatter mirror, and individual electromagnetic radiation detectors is selectively, movably adjustable in both a predetermined horizontal, and vertical planes.

3. An electromagnetic radiation detector assembly, as claimed in claim 2, and wherein the source of electromagnetic radiation includes a narrow beam of electromagnetic radiation which includes one or more predetermined bands of electromagnetic radiation, and wherein the other source of electromagnetic radiation coming from the direction of the object of interest is generated, at least in part, by a selectively energizable background element.

4. An electromagnetic radiation detector assembly, as claimed in claim 2, and wherein the bulk and/or surface scattered, electromagnetic radiation coming from the object of interest, each share a common, electromagnetic radiation signal path, and wherein the optical scatter mirror is oriented along the common, electromagnetic radiation signal path, and wherein at least one of the individual electromagnetic radiation detectors which are made integral with the electromagnetic radiation detector assembly is oriented in spaced, laterally outwardly disposed relation relative to the common, electromagnetic radiation signal path, and wherein at least one of the individual, electromagnetic radiator detectors is coaxially aligned relative to the common, electromagnetic radiation signal path, and wherein the optical scatter mirror is coaxially aligned relative to the common, electromagnetic radiation signal path by movably adjusting the position of the housing in the horizontal and vertical planes relative to the electromagnetic radiation signal path.

5. An electromagnetic radiation detector assembly, as claimed in claim 4, and wherein the optical scatter mirror is a planar mirror which is oriented in a non-perpendicular, and at least a partially reflecting, orientation relative to the common, electromagnetic radiation signal path, and which reflects, at least in part, and passes, at least in part, the scattered electromagnetic radiation, and/or other electromagnetic radiation coming from the direction of the object of interest in the direction of at least one of electromagnetic radiation detectors.

6. An electromagnetic radiation detector assembly, as claimed in claim 5, and wherein the optical scatter mirror has an aperture formed in a predetermined location therein, and which extends therethrough, and wherein the aperture formed in the optical scatter mirror is substantially coaxially aligned with the common, electromagnetic radiation signal path, and wherein the optical scatter mirror is located between the object of interest, and at least one of the electromagnetic radiation detectors, and which is further individually, coaxially aligned with the common, electromagnetic radiation signal path.

7. An electromagnetic radiation detector assembly as claimed in claim 6, and wherein the aperture formed in the optical scatter mirror, has a given shape which is correlated with the predetermined non-perpendicular orientation of the optical scatter mirror as measured relative to the common, electromagnetic radiation signal path.

8. An electromagnetic radiation detector assembly as claimed in claim 7, and wherein the aperture formed in the optical scatter mirror includes a centrally disposed obscuration which renders the optical scatter mirror effective to function as a bulk scattered spatial input filter for the electromagnetic radiation which comes from the direction of the object of interest.

9. An electromagnetic radiation detector assembly, as claimed in claim 7, and wherein the aperture formed in the optical scatter mirror is non-occluded, and which further renders the optical scatter mirror effective to function as a surface scattered spatial input filter for the electromagnetic radiation which comes from the direction of the object of interest, and wherein the aperture has a length dimension, and further has a variable cross-sectional dimension when measured along the length dimension, thereof.

10. An electromagnetic radiation detector assembly as claimed in claim 7, and further comprising:
an optical filter mounted on the housing and which operates to optically select, and then optically pass, surface scattered electromagnetic radiation having a predetermined polarization, and which is coming from the direction of the object of interest, and wherein the aperture formed in the optical scatter mirror is non-occluded, and which renders the optical scatter mirror effective to function as a polarized, surface scattered spatial input filter for the electromagnetic radiation which comes from the direction of the object of interest.

11. An electromagnetic radiation detector assembly, as claimed in claim 10, and wherein the optical filter having the predetermined polarization optically selects, and then optically passes, vertically oriented, surface scattered electromagnetic radiation.

12. An electromagnetic radiation detector assembly, as claimed in claim 10, and wherein the optical filter having the predetermined polarization optically selects, and then optically passes, horizontally oriented, surface scattered electromagnetic radiation.

13. An electromagnetic radiation detector assembly as claimed in claim 8, and wherein at least one of the individual electromagnetic radiation detectors include a bulk scatter electromagnetic radiation detector which is coaxially oriented relative to the aperture formed in the optical scatter mirror, and which receives, and optically passes the bulk, scattered electromagnetic radiation which comes from the direction of the object of interest; and a surface scatter electromagnetic radiation detector is located laterally, outwardly relative to the optical scatter mirror, and which further receives the surface scattered electromagnetic radiation coming from the direction of the object of interest, and which is further reflected by the optical scatter mirror in the direction of the surface scattered electromagnetic radiation detector.

14. An electromagnetic radiation detector assembly, as claimed in claim 8, and wherein at least one of electromagnetic radiation detectors include a surface scatter electromagnetic radiation detector which is coaxially oriented relative to the aperture formed in the optical scatter mirror, and which receives, and then optically passes the surface scattered electromagnetic radiation which comes from the direction of the object of interest; and a bulk scatter electromagnetic radiation detector is located laterally, outwardly relative to the optical scatter mirror, and which further receives the bulk scattered electromagnetic radiation coming from the direction of the object of interest, and which is further reflected by the optical scatter mirror in the direction of the bulk scattered electromagnetic radiation detector.

15. An electromagnetic radiation detector assembly as claimed in claim 8, and further comprising:
an electromagnetic radiation polarization detector borne by the housing of the electromagnetic radiation detector assembly, and which is coaxially oriented relative to the non-occluded aperture formed in the optical scatter mirror so as to detect a given polarization of the surface scattered electromagnetic radiation which is received by the optical scatter mirror.

16. An electromagnetic radiation detector assembly, as claimed in claim 13, and further comprising:
a fluorescence electromagnetic radiation detector mounted on the housing and positioned in a given orientation relative to the optical scatter mirror, and which further detects a given fluorescent electromagnetic radiation coming from the direction of the object of interest.

17. An electromagnetic radiation detector assembly, comprising:
a housing having a main body with an outside facing surface, and an opposite, inside facing surface which defines an internal cavity having multiple discreet regions;
an optical scatter mirror located within a first discreet region of the internal cavity, and wherein the optical scatter mirror has an aperture which is formed therein, and which further passes therethrough;
an optical beam splitter located within a second discreet region of the internal cavity, and which is further positioned in an optical receiving relationship relative to the aperture formed in the optical scatter mirror;
a first electromagnetic radiation detector mounted in a first, predetermined location on the outside facing surface of the housing, and in a first, optical receiving orientation relative to the optical beam splitter;
a second electromagnetic radiation detector mounted in a second, predetermined location on the outside facing surface of the housing, and in a second, optical receiving orientation relative to the optical beam splitter;
a third electromagnetic radiation detector mounted in a third, predetermined location on the outside facing surface of the housing, and in an optical receiving orientation relative to the optical scatter mirror; and
an optical bandpass filter which is mounted on the housing and disposed in an optical transmitting relationship relative to the optical scatter mirror, and which further passes a source of electromagnetic radiation which is optically scattered, at least in part, from an object of interest in bulk, and/or from a surface thereof, into the first discreet region of the internal cavity and to the optical scatter mirror which is located within the first discreet region of the internal cavity, and wherein the optical scatter mirror reflects and/or passes, at least in part, a portion of the scattered electromagnetic radiation which is passed by the optical band pass filter.

18. An electromagnetic radiation detector assembly as claimed in claim 16, and wherein the main body of the housing is selectively adjustable in a predetermined horizontal and vertical planes.

19. An electromagnetic radiation detector assembly as claimed in claim 17, and wherein the aperture formed in the optical scatter mirror includes a centrally disposed obscuration which renders the optical scatter mirror effective to function as a bulk scattered spatial input filter for the electromagnetic radiation which is scattered from the object of interest, and passed by the optical band pass filter.

20. An electromagnetic radiation detector assembly, as claimed in claim 17, and wherein the aperture formed in the optical scatter mirror is non-occluded, and which further renders the optical scatter mirror effective to function as a surface scattered spatial input filter for the electromagnetic radiation which is scattered from the object of interest, and passed by the optical band pass filter.

21. An electromagnetic radiation detector assembly, as claimed in claim 17, and wherein the aperture formed in the optical scatter mirror, has a given shape which is correlated with a predetermined, non-perpendicular orientation of the optical scatter mirror as measured relative to a common, electromagnetic radiation signal path which is established, and which further extends from the object of interest, through the optical bandpass filter, and to the optical scatter mirror which is positioned within the first discreet region of the internal cavity, and wherein the orientation of the optical scatter mirror relative to the common, electromagnetic radiation signal path is accomplished by movably adjusting the housing in the predetermined vertical and horizontal planes.

22. An electromagnetic radiation detector assembly, as claimed in claim 17, and further comprising:
a first lens supported, at least in part, within a third discreet region of the internal cavity of the housing, and which is further positioned therebetween the optical beam splitter, and the first, electromagnetic radiation detector;
a second lens supported, at least in part, within a fourth discreet region of the internal cavity of the housing, and which is further positioned therebetween the optical beam splitter, and the second, electromagnetic radiation detector; and
a third lens positioned in optical receiving relation relative to the optical scatter mirror, and which is further positioned in an optical transmitting relationship relative to the third, electromagnetic radiation detector.

23. An electromagnetic radiation detector assembly, as claimed in 17, and wherein the first, second and third electromagnetic radiation detectors which are made integral with the electromagnetic radiation detector assembly are spatially oriented in predetermined, fixed locations relative to the optical scatter mirror, so as to selectively detect, with an improved signal-to-noise ratio, the scattered electromagnetic radiation, and/or another source of electromagnetic radiation coming from the direction of the object of interest, and then generate a resulting image signal having improved contrast.

24. An electromagnetic radiation detector assembly as claimed in claim 17, and wherein the bulk and/or surface scattered, electromagnetic radiation coming from the direction of the object of interest, each share a common, electromagnetic radiation signal path, and wherein the optical scatter mirror is oriented along the common, electromagnetic radiation signal path, and wherein the second and third electromagnetic radiation detectors which are made integral with the electromagnetic radiation detector assembly are oriented in a spaced, laterally outwardly disposed relationship relative to the common, electromagnetic radiation signal path, and wherein the first, electromagnetic radiation detector is coaxially aligned relative to the common, electromagnetic radiation signal path by the selective movable adjustment of the housing in the predetermined horizontal and vertical planes.

25. An electromagnetic radiation detector assembly as claimed in claim 23, and wherein the optical scatter mirror is a planar mirror which is oriented in a non-perpendicular, and at least a partially reflecting, orientation relative to the common, electromagnetic radiation signal path, and which further directs, at least in part, the scattered electromagnetic radiation, and/or other electromagnetic radiation coming from the direction of the object of interest in the direction of the third electromagnetic radiation detector, and wherein the optical scatter mirror has an aperture formed in a predetermined location therein, and which further extends therethrough, and wherein the aperture is substantially, coaxially aligned with the common, electromagnetic radiation signal path by the selective moveably adjustment of the housing, and wherein the optical scatter mirror is further located between the object of interest, and the first, electromagnetic radiation detector.

26. An electromagnetic radiation detector assembly as claimed in claim 22, and further comprising:
a first, optical polarizing lens which is mounted near an outwardly facing sidewall of the housing, and which is further oriented in a spaced, optical receiving relationship relative to the optical band pass filter, and wherein the first, optical polarizing lens is further positioned in optical transmitting relation relative to the first, discreet region of the internal cavity, as defined by the housing, and the optical scatter mirror which is positioned within the first, discreet region, and wherein the first, optical band pass filter is further oriented along the common, electromagnetic radiation signal path; and
a second, optical polarizing lens which is mounted near the upper, outside facing surface of the housing, and which is further oriented in optical receiving relation relative to the first, discreet region of the internal cavity of the housing, and the optical scatter mirror which is positioned within the first, discreet region of the housing, and wherein the second, optical polarizing lens is further positioned in optical transmitting relation relative to the third lens, and wherein the optical scatter mirror; second, optical polarizing lens; third lens; and the third electromagnetic radiation detector are each oriented along a predetermined line of reference which is oriented in a perpendicular relationship relative to the common, electromagnetic radiation signal path.

27. An electromagnetic radiation detector assembly, comprising:
a selectively adjustable base plate for supporting the electromagnetic radiation detector in a predetermined horizontal and vertical orientation, and wherein the base plate has an upwardly, and outwardly facing supporting surface, and which is further defined, in part, by a peripheral edge;
a housing having a main body which defines an internal cavity having predetermined first, second, third and fourth regions, and which further has spaced apart, upper and lower outwardly facing surfaces, and first, second, third and fourth, outwardly facing sidewall surfaces which individually extend between the upper and lower outwardly facing surfaces of the housing, and wherein the lower and outwardly facing surface of the housing is mounted on the upwardly, and outwardly facing supporting surface of the selectively adjustable base plate;
an optical scatter mirror mounted in a predetermined spatial and optically reflecting and transmitting orientation within the first region of the internal cavity as defined by the housing, and wherein the optical scatter mirror has an aperture formed therein, and which further extends therethrough;
an optical beam splitter positioned within the second region of the internal cavity as defined by the housing, and wherein the optical beam splitter is located in a predetermined, spaced relationship, and in an optical receiving relationship relative to the optical scatter mirror;
a first lens received, and supported, at least in part, within the third region of the internal cavity as defined by the housing, and wherein the first lens is positioned in a predetermined, spaced relationship, and in an optical receiving relationship relative to the optical beam splitter, and wherein the optical scatter mirror, optical beam splitter and first lens are linearly aligned along a first, predetermined line of reference, one relative to the others;
a first electromagnetic radiation detector which is mounted on the third, outwardly facing sidewall surface of the housing, and which is further oriented in an optical receiving relationship relative to the first lens;
a second lens received and supported, at least in part, within the fourth region of the internal cavity as defined by the housing, and wherein the second lens is positioned in an optical receiving relation relative to the optical beam splitter, and is further spatially oriented, laterally outwardly relative to the first, predetermined line of reference as defined, at least in part, by the optical scatter mirror, optical beam splitter, and the first lens;
a second electromagnetic radiation detector mounted on the second, outwardly facing sidewall surface of the housing, and which is further oriented in an optical receiving relationship relative to the second lens;
a sensor mounting plate having a predetermined, spaced, outwardly facing, top and bottom surfaces, and which further defines an optical passageway which communicates with both of the outwardly facing, top, and bottom surfaces thereof, and wherein the outwardly facing, bottom surface of the sensor mounting plate is mounted on the upper, outwardly facing surface of the housing, and wherein the internal cavity of the sensor mounting plate is oriented in an optical receiving relationship relative to the optical scatter mirror, and which is further located within the first region as defined by the internal cavity of the housing;
a third lens which is received and supported, at least in part, within the optical passageway as defined by the sensor mounting plate, and wherein the third lens is oriented in an optical receiving relationship relative to the first region of the internal cavity as defined by the housing;
a third electromagnetic radiation detector which is mounted on the top, outwardly facing surface of the sensor mounting plate, and which is further oriented in an optical receiving relationship relative to the third lens;
an optical bandpass filter which is mounted in a spaced relationship relative to the first, outwardly facing sidewall of the housing, and which is further positioned in an optical transmitting relationship relative to the first region of the internal cavity, as defined by the housing, and the optical scatter mirror which is positioned within the first region, and wherein the optical band pass filter is further oriented along the first, predetermined line of reference;
a first, optical polarizing lens which is mounted on the first, outwardly facing sidewall of the housing, and which is further oriented in a spaced, optical receiving relationship relative to the optical band pass filter, and wherein the first, optical polarizing lens is further positioned in an optical transmitting relationship relative to the first region of the internal cavity, as defined by the housing, and the optical scatter mirror which is positioned within the first region, and wherein the first, optical band pass filter is further oriented along the first, predetermined line of reference; and
a second, optical polarizing lens which is mounted on the outside facing, bottom surface of the sensor mounting plate, and which is further oriented in an optical receiving relationship relative to the first region of the internal cavity of the housing, and the optical scatter mirror which is positioned within the first region of the housing, and wherein the second, optical polarizing lens is further positioned in an optical transmitting relationship relative to the third lens which is supported, at least in part, within the optical passageway as defined by the sensor mounting plate, and wherein the optical scatter mirror; second, optical polarizing lens; third lens; and the third electromagnetic radiation detector are each oriented along a second, predetermined line of reference and which is further oriented in a perpendicular relationship relative to the first, predetermined line of reference.

28. An electromagnetic radiation detector assembly, as claimed in claim 24, and further comprising:
a source of electromagnetic radiation which is directed at an object of interest, and which is further optically scattered, at least in part, from the object of interest in bulk, and/or from a surface thereof, and which further moves in a direction towards the electromagnetic radiation detector assembly, and wherein the optical scatter mirror which is made integral with the electromagnetic radiation detector assembly simultaneously optically interacts with the source of the bulk and/or surface scattered electromagnetic radiation coming from the object of interest so as to function, at least in part, as either a bulk scatter, and/or a surface scatter spatial input filter, and wherein the first, second, and third electromagnetic radiation detectors which are made integral with the electromagnetic radiation detector assembly are further spatially oriented in predetermined, fixed locations relative to the optical scattering mirror so as to selectively detect, with an improved signal-to-noise ratio, the bulk scattered electromagnetic radiation; surface scattered electromagnetic radiation; and/or another source of electromagnetic radiation coming from the direction of the object of interest, and then generate a resulting image signal having improved contrast

29. An electromagnetic radiation detector assembly as claimed in claim 25, and wherein the source of electromagnetic radiation includes a narrow band of electromagnetic radiation which is passed by the optical band pass filter, and which further includes one or more predetermined bands of electromagnetic radiation, and wherein the other source of electromagnetic radiation coming from the direction of the object of interest is generated by a selectively energizable background element.

30. An electromagnetic radiation detector assembly, as claimed in claim 26, and wherein the bulk and/or surface scattered, electromagnetic radiation coming from the object of interest, each share a common, electromagnetic radiation signal path, and wherein the first, predetermined line of reference is coaxially aligned with the common, electromagnetic radiation signal path, and wherein the second and third electromagnetic radiation detectors which are made integral with the electromagnetic radiation detector assembly are oriented in a spaced, laterally outwardly disposed relationship relative to the common, electromagnetic radiation signal path, and the first, predetermined line of reference, and wherein the first, electromagnetic radiator detector is coaxially aligned relative to the common, electromagnetic radiation signal path by a selective adjustment of the housing in a predetermined horizontal and vertical plane by means of the selectively adjustable base plate.

31. An electromagnetic radiation detector assembly as claimed in claim 33, and wherein the optical scatter mirror is a planar mirror which is oriented in a non-perpendicular, and at least a partially reflecting, and a partially optically transmitting position relative to the common, electromagnetic radiation signal path, and which further directs, at least in part, the scattered electromagnetic radiation, and/or other electromagnetic radiation coming from the direction of the object of interest in the direction of the third electromagnetic radiation detector, and wherein the optical scatter mirror has an aperture formed in a predetermined location therein, and which further extends therethrough, and wherein the aperture is substantially, coaxially aligned with the common, electromagnetic radiation signal path, and wherein the optical scatter mirror is further located between the object of interest, and the first, electromagnetic radiation detector.

32. An electromagnetic radiation detector assembly as claimed in claim 28, and wherein the aperture formed in the optical scatter mirror, has a given shape which is correlated with the predetermined non-perpendicular orientation of the optical scatter mirror as measured relative to the common, electromagnetic radiation signal path so as to further function as an optical filter.

33. An electromagnetic radiation detector assembly as claimed in claim 28, and wherein the aperture formed in the optical scatter mirror includes a centrally disposed obscuration which renders the optical scatter mirror effective to function as a bulk scattered spatial input filter for the scattered electromagnetic radiation which comes from the direction of the object of interest.

34. An electromagnetic radiation detector assembly, as claimed in claim 28, and wherein the aperture formed in the optical scatter member is non-occluded, and which further renders the optical scatter mirror effective to function as a surface scattered spatial input filter for the electromagnetic radiation which comes from the direction of the object of interest.

35. An electromagnetic radiation detector assembly as claimed in claim 28, and wherein the first optical polarizing lens selects, and then optically passes, surface scattered electromagnetic radiation having a predetermined polarization, and which further is coming from the direction of the object of interest, and wherein the aperture formed in the optical scatter mirror is non-occluded, and which renders the optical scatter mirror effective to function as a polarized, surface scattered spatial input filter for the electromagnetic radiation which comes from the direction of the object of interest.

36. An electromagnetic radiation detector assembly, as claimed in claim 32, and wherein the first optical polarizing lens having the predetermined polarization selects, and then optically passes, vertically oriented, surface scattered electromagnetic radiation.

37. An electromagnetic radiation detector assembly, as claimed in claim 32, and wherein the first optical polarizing lens having the predetermined polarization selects, and then passes, horizontally oriented, surface scattered electromagnetic radiation.

38. An electromagnetic radiation detector assembly as claimed in claim 28, and wherein at least one of the first, second or third electromagnetic radiation detectors include a bulk scatter electromagnetic radiation detector which is coaxially oriented relative to the aperture formed in the optical scatter mirror, and which receives, and then optically passes the bulk scattered electromagnetic radiation which comes from the direction of the object of interest; and a surface scatter electromagnetic radiation detector which is located laterally, outwardly relative to the optical scatter mirror, and which further optically receives the surface scattered electromagnetic radiation coming from the direction of the object of interest, and which is further reflected by the optical scatter mirror, and in the direction of the surface scattered electromagnetic radiation detector.

39. An electromagnetic radiation detector assembly as claimed in claim 35, and wherein the first, second and third lenses are each ball lenses.
